(19) United States
(12) Patent Application Publication
(10) Pub. No.: US 2024/0326152 A1
(43) Pub. Date: Oct. 3, 2024

(54) METHOD FOR MANUFACTURING WELDED STRUCTURE

(71) Applicants: Yosuke TAMADA, Toyota-shi (JP); Koji NOMURA, Toyota-shi (JP); Tomohiko SEKIGUCHI, Nagakute-shi (JP); Keigo YASUDA, Okazaki-shi (JP)

(72) Inventors: Yosuke TAMADA, Toyota-shi (JP); Koji NOMURA, Toyota-shi (JP); Tomohiko SEKIGUCHI, Nagakute-shi (JP); Keigo YASUDA, Okazaki-shi (JP)

(73) Assignees: TOYOTA JIDOSHA KABUSHIKI KAISHA, Toyota-shi (JP); FUTABA INDUSTRIAL CO., LTD., Okazaki-shi (JP)

(21) Appl. No.: 18/599,722

(22) Filed: Mar. 8, 2024

(30) Foreign Application Priority Data
Mar. 30, 2023 (JP) 2023-054976

(51) Int. Cl. B23K 11/11; B23K 11/24; B23K 101/18

(52) U.S. Cl. CPC B23K 11/115; B23K 11/24; B23K 2101/18

(57) ABSTRACT

A method for manufacturing a welded structure and a welding apparatus capable of reducing formation of burrs are provided. The method for manufacturing the welded structure according to the present disclosure is the method for manufacturing the welded structure formed by spot-welding a laminate formed of three or more metal plates, at least one metal plate of the three or more metal plates being thinner than the other metal plates. This manufacturing method includes a step of energizing a welding point of the laminate while pressurizing it and causing a main current to flow through the welding point of the laminate and a step of continuously energizing the welding point of the laminate while pressurizing it and causing a large current that is larger than the main current to flow through the welding point of the laminate.

### CROSS REFERENCE TO RELATED APPLICATIONS

This application is based upon and claims the benefit of priority from Japanese patent application No. 2023-054976, filed on Mar. 30, 2023, the disclosure of which is incorporated herein in its entirety by reference.

### BACKGROUND

The present disclosure relates to a method for manufacturing a welded structure and a welding apparatus.

Japanese Patent No. 7038193 discloses a spot welding method for joining a laminate formed by laminating three or more metal plates to one another, at least one of the three or more metal plates being formed so as to have a thickness different from those of the other metal plates, using a pulse current.

### SUMMARY

The applicants have found the following problem.

When the distance between a welded welding point and a welding point to be welded becomes short, burrs are likely to be formed. When, for example, a welding point that is positioned between welding points that have already been welded is energized while it is pressurized, a current may be diverted to the welded welding points, and burrs may be formed at the energized welding point. The burrs are formed when, for example, molten metal generated just below the welding points at the time of energization is ejected from the surfaces of the welding points and hardens.

The present disclosure has been made in view of the aforementioned problem, and provides a method for manufacturing a welded structure and a welding apparatus capable of reducing formation of burrs.

A method for manufacturing a welded structure according to the present disclosure is a method for manufacturing a welded structure formed by spot-welding a laminate formed of three or more metal plates laminated to one another, at least one of the three or more metal plates being thinner than the other metal plates, the method including: energizing a welding point of the laminate while pressurizing it and causing a main current to flow through the welding point of the laminate; and continuously energizing the welding point of the laminate while pressurizing it and causing a large current that is larger than the main current to flow through the welding point of the laminate, in which a period t₁ during which the main current is made to flow through the welding point of the laminate is longer than a period t₂ during which the large current is made to flow through the welding point of the laminate.

Further, in the aforementioned method for manufacturing the welded structure, the period t₁ during which the main current is made to flow through the welding point of the laminate may be 2.50 or more times longer than the period t₂ during which the large current is made to flow through the welding point of the laminate.

Further, in the aforementioned method for manufacturing the welded structure, a current value A2 of the large current may be 12 kA or larger.

A method for manufacturing a welded structure according to the present disclosure is a method for manufacturing a welding structure formed by spot-welding a laminate formed of three or more metal plates laminated to one another, at least one of the three or more metal plates being thinner than the other metal plates, the method including: energizing a welding point of the laminate while pressurizing it and causing a matching current to flow through the welding point of the laminate; continuously energizing the welding point of the laminate while pressurizing it and causing a large current to flow through the welding point of the laminate; and continuously energizing the welding point of the laminate while pressurizing it and causing a main current that is smaller than the large current to flow through the welding point of the laminate, in which a current value A13 of the matching current is smaller than a current value A11 of the main current.

Further, in the aforementioned method for manufacturing the welded structure, a period t₁₁ during which the main current is made to flow through the welding point of the laminate may be 2.50 or more times longer than a period t₁₂ during which the large current is made to flow through the welding point of the laminate.

Further, in the aforementioned method for manufacturing the welded structure, a period t₁₁ during which the main current is made to flow through the welding point of the laminate may be longer than a period t₁₃ during which the matching current is made to flow through the welding point of the laminate by 3.00 or less times.

Further, in the aforementioned method for manufacturing the welded structure, the current value A13 of the matching current may be 0.95 or less times as large as the current value A11 of the main current.

Further, in the aforementioned method for manufacturing the welded structure, the laminate may include a welded welding point that has already been welded, and the welding point of the laminate may be within 15 mm from the welded welding point.

A method for manufacturing a welded structure according to the present disclosure is a method for manufacturing a welded structure formed by spot-welding a laminate formed of three or more metal plates laminated to one another, at least one of the three or more metal plates being thinner than the other metal plates, the method including: determining, based on a position of a welding point to be welded, a method for welding the welding point to be welded, in which, in the determination of the welding method, when a distance between the welding point to be welded and a welded welding point exceeds a predetermined value, the welding point of the laminate is energized while it is pressurized and a large current is made to flow through the welding point of the laminate, and then the welding point of the laminate is continuously energized while it is pressurized and a main current that is smaller than the large current is made to flow through the welding point of the laminate, and when the distance between the welding point to be welded and the welded welding point is a predetermined value or smaller, the welding point to be welded is welded using a welding method in which the welding point of the laminate is energized while it is pressurized and a main current is made to flow through the welding point of the laminate, and then the welding point of the laminate is continuously energized while it is pressurized and a large current that is larger than the main current is made to flow through the welding point of the laminate, and a period t₁ during which the main current is made to flow through the welding point of the laminate is longer than a period t₂ during which the large current is made to flow through the welding point of the laminate.

A method for manufacturing a welded structure according to the present disclosure is a method for manufacturing a welded structure formed by spot-welding a laminate formed of three or more metal plates laminated to one another, at least one of the three or more metal plates being thinner than the other metal plates, the method including: determining, based on a position of a welding point to be welded, a method for welding the welding point to be welded, in which, in the determination of the welding method, when a distance between the welding point to be welded and a welded welding point exceeds a predetermined value, the welding point of the laminate is energized while it is pressurized and a large current is made to flow through the welding point of the laminate, and then the welding point of the laminate is continuously energized while it is pressurized and a main current that is smaller than the large current is made to flow through the welding point of the laminate, and when the distance between the welding point to be welded and the welded welding point is a predetermined value or smaller, the welding point to be welded is welded using a welding method in which the welding point of the laminate is energized while it is pressurized, a matching current is made to flow through the welding point of the laminate, and then the welding point of the laminate is continuously energized while it is pressurized and a large current is made to flow through the welding point of the laminate, and then the welding point of the laminate is continuously energized while it is pressurized and a main current that is smaller than the large current is made to flow through the welding point of the laminate, and a current value A13 of the matching current is smaller than a current value A11 of the main current.

A welding apparatus according to the present disclosure is a welding apparatus configured to spot-weld a laminate formed of three or more metal plates laminated to one another, at least one of the three or more metal plates being thinner than the other metal plates, the welding apparatus including: an electrode configured to pressurize a welding point of the laminate; a current generation circuit configured to cause a current to flow through the welding point of the laminate pressurized by the electrode; and a current control unit configured to perform, by controlling the current generation circuit, a first control for maintaining the current to be a main current and a second control for maintaining the current to be a large current that is larger than the main current after maintaining the current to be the main current, in which a period t₁ during which the main current is made to flow through the welding point of the laminate is longer than a period t₂ during which the large current is made to flow through the welding point of the laminate.

A welding apparatus according to the present disclosure is a welding apparatus for spot-welding a laminate formed of three or more metal plates laminated to one another, at least one of the three or more metal plates being thinner than the other metal plates, the welding apparatus including: an electrode configured to pressurize a welding point of the laminate; a current generation circuit configured to cause a current to flow through the welding point of the laminate pressurized by the electrode; and a current control unit configured to perform, by controlling the current generation circuit, a first control for maintaining the current at a matching current, a second control for maintaining the current at a large current after maintaining the current at the matching current, and a third control for maintaining the current at a main current smaller than the large current after maintaining the current at the large current, in which the matching current is smaller than the main current.

According to the present disclosure, it is possible to reduce formation of burrs.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a flowchart showing a method for manufacturing a welded structure according to a first embodiment;

FIG. 2 is a schematic view showing one step of the method for manufacturing the welded structure according to the first embodiment;

FIG. 3 is a graph showing changes in a current in the method for manufacturing the welded structure according to the first embodiment;

FIG. 4 is a schematic view showing a positional relation between welded welding points and a welding point to be welded;

FIG. 5 is a flowchart showing a method for manufacturing a welded structure according to a second embodiment;

FIG. 6 is a graph showing changes in a current in the method for manufacturing the welded structure according to the second embodiment;

FIG. 7 is a flowchart showing a method for manufacturing a welded structure according to art related to the present disclosure;

FIG. 8 is a schematic view showing one step of the method for manufacturing the welded structure according to the art related to the present disclosure;

FIG. 9 is a graph showing a current curve in the method for manufacturing the welded structure according to the art related to the present disclosure; and

FIG. 10 shows a photograph of burrs that are formed in the welded welding point.

### DESCRIPTION OF EMBODIMENTS

### Related Art

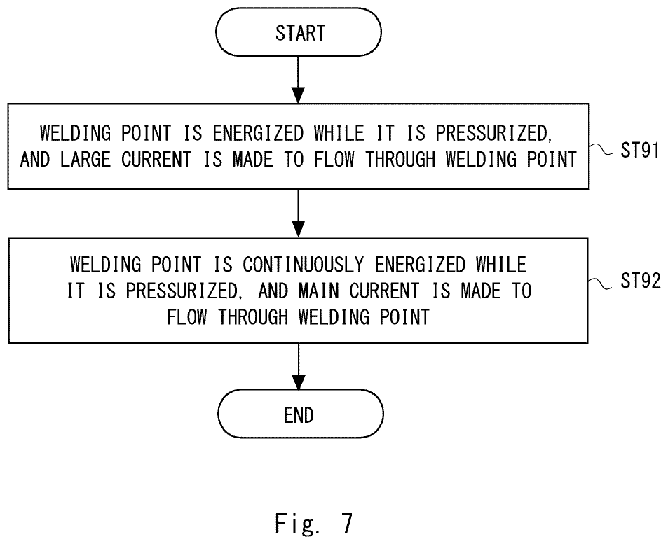

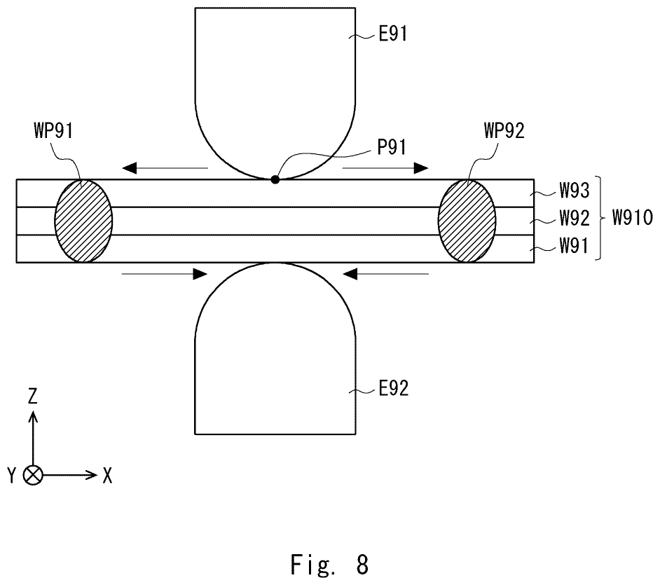

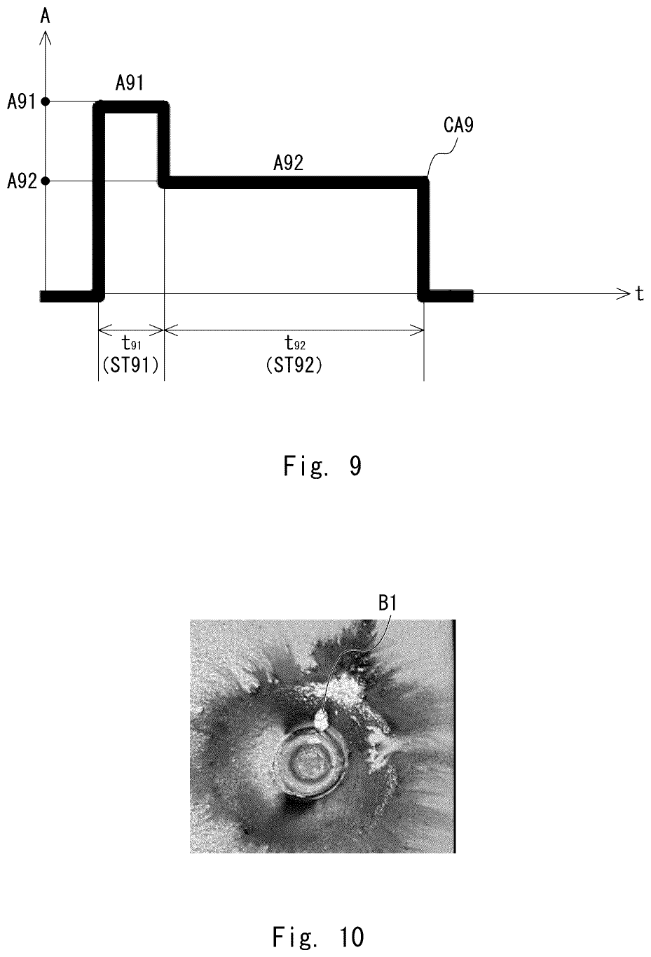

Prior to giving the description of specific embodiments to which the present disclosure is applied, with reference to FIGS. 7-9, a method for manufacturing a welded structure according to art related to the present disclosure will be described. FIG. 7 is a flowchart showing a method for manufacturing a welded structure according to art related to the present disclosure. FIG. 8 is a schematic view showing one step of the method for manufacturing the welded structure shown in FIG. 7. FIG. 9 is a graph showing a current curve in the method for manufacturing the welded structure shown in FIG. 7.

As shown in FIGS. 7 and 8, a welding point P91 of a laminate W910 is energized while it is pressurized, and a large current is made to flow through the welding point P91 of the laminate W910 (step ST91). Specifically, the laminate W910 is formed of three or more metal plates laminated to one another, and at least one of the three or more metal plates is thinner than the other metal plates. One example of the laminate W910 shown in FIG. 8 is formed of metal plates W91, W92, and W93 laminated to one another in this order. A large current is made to flow while electrodes E91 and E92 keep pressing the welding point P91. The large current is made to flow through the welding point P91 of the laminate W910 for a period t₉₁. The current value of the large current is larger than the current value of a main current that flows in step ST92. A current curve CA9 shown in FIG. 9 shows changes in the current value according to this manufacturing method. The current value of the large current is a current value A91.

Next, the welding point P91 of the laminate W910 is continuously energized while it is pressurized, and a main current is made to flow through the welding point P91 of the laminate W910 (step ST92). The current value of the main current is a current value A92 shown in FIG. 9, which is smaller than the current value A91. Specifically, the current is decreased from the current value A91 to the current value A92, and the welding point P91 is continuously energized while it is pressurized. The main current is made to flow through the welding point P91 of the laminate W910 for a period t₉₂. Further, the period t₉₂ is longer than the period t₉₁.

In the aforementioned method for manufacturing the welded structure according to the art related to the present disclosure, burrs are often formed. As shown in FIG. 8, in step ST91, the large current may flow through welded welding points WP91 and WP92 in a divided manner from the welding point P91 in a planar direction (in this example, X-axis direction) of the laminate W910. When a current flows through the welded welding points WP91 and WP92 in a divided manner, burrs are often formed in the welding point P91. Further, when the distance between the welding point P91 and the welded welding points WP91 and WP92 is short, a current is likely to flow through the welded welding points WP91 and WP92 in a divided manner, and burrs are likely to be formed in the welding point P91.

The applicants have conceived of the present disclosure by diligently studying various factors such as the magnitude of the current, the period, the order, and the like, focusing on the fact that a current has an influence on the formation of burrs.

Hereinafter, with reference to the drawings, specific embodiments to which the present disclosure is applied will be described in detail. However, the present disclosure is not limited to the following embodiments. Further, for the sake of clarification of the description, the following descriptions and the drawings are simplified as appropriate.

### First Embodiment

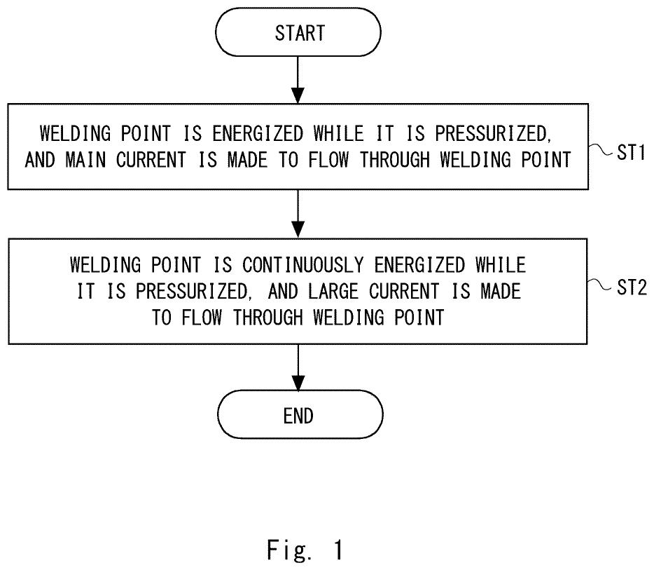

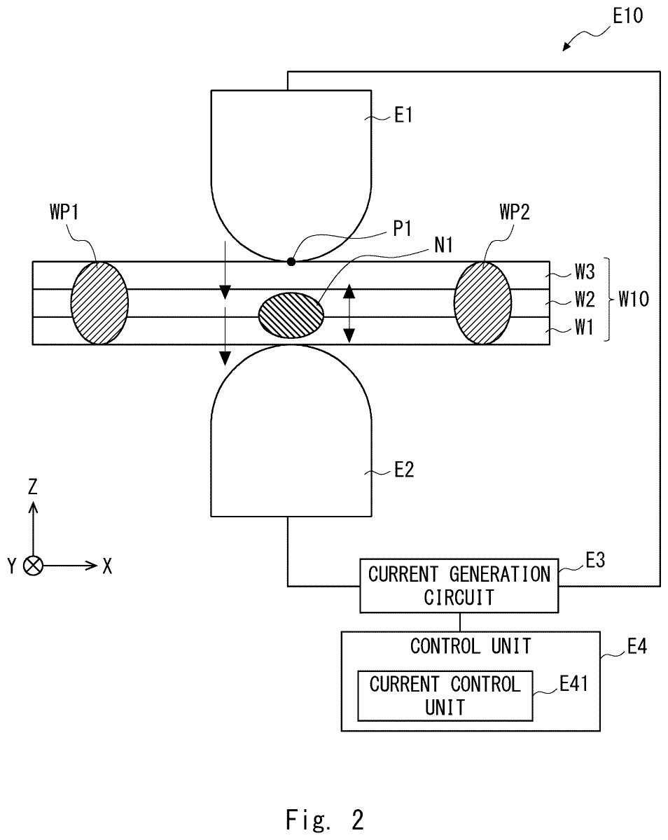

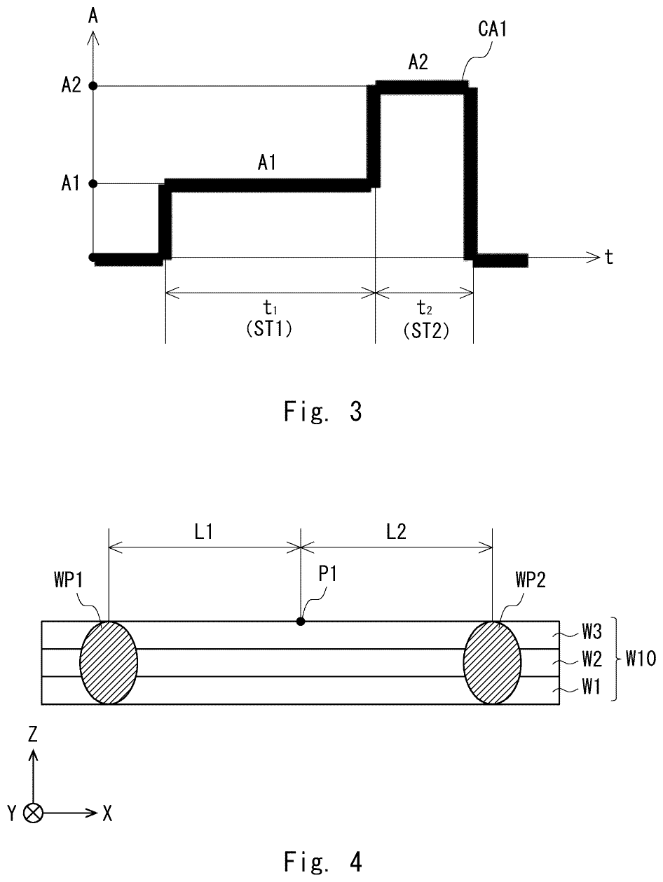

With reference to FIGS. 1 to 4, a first embodiment will be described. FIG. 1 is a flowchart showing a method for manufacturing a welded structure according to the first embodiment. FIG. 2 is a schematic view showing one step of the method for manufacturing the welded structure shown in FIG. 1. FIG. 3 is a graph showing changes in a current in the method for manufacturing the welded structure shown in FIG. 1. FIG. 4 is a schematic view showing a positional relation between welded welding points and a welding point to be welded.

As a matter of course, the right-handed XYZ-coordinate system shown in FIG. 2 and the other drawings is used for the sake of convenience to illustrate a positional relation among components. In general, as is common among the drawings, a Z-axis positive direction is a vertically upward direction and an XY-plane is a horizontal plane.

In the method for manufacturing the welded structure according to the first embodiment, a welding apparatus E10 shown in FIG. 2 can be used. The welding apparatus E10 includes electrodes E1 and E2, a current generation circuit E3, and a control unit E4. The electrodes E1 and E2 are gripped by a movable arm or the like (not shown) so that they can be moved. The electrodes E1 and E2 pressurize a welding point P1 of a laminate W10 by holding it and pressing it by the movable arm or the like. The current generation circuit E3 is electrically connected to a power supply (not shown) and generates a current from the power supply. The current generation circuit E3 causes a current to flow through the welding point P1 of the laminate W10 pressurized by the electrodes E1 and E2. The control unit E4 may control operations of the electrodes E1 and E2 via the movable arm or the like. The control unit E4 includes a current control unit E41. The current control unit E41 is able to control the current generation circuit E3 and change the magnitude of the current that the current generation circuit E3 flows over time.

As shown in FIG. 2, the welding point P1 of the laminate W10 is energized while it is pressurized, and a main current is made to flow through the welding point P1 of the laminate W10 (step ST1). Specifically, the laminate W10 is formed of three or more metal plates laminated to one another. Further, in the laminate W10, at least one of the three or more metal plates is thinner than the other metal plates. That is, the laminate W10 is a board set having a high plate thickness ratio. One example of the laminate W10 shown in FIG. 2 is formed by metal plates W1, W2, and W3 laminated to one another in this order. The metal plate W3 is thinner than the metal plate W1 and the metal plate W2. The metal plates W1, W2, and W3 may be, for example, steel plates whose types are different from one another. The main current is made to flow while the electrodes E1 and E2 keep pressing the welding point P1. As shown in FIGS. 2 and 3, the main current is made to flow through the welding point P1 of the laminate W10 at a current value A1 for a period t₁. The electrodes E1 and E2 are preferably electrically connected to a power supply (not shown). This power supply preferably causes the current to flow through the laminate W10 via the electrodes E1 and E2 as appropriate. Further, the diameters of the electrodes E1 and E2 and the welding pressure at which the electrodes E1 and E2 press the welding point P1 may be selected as appropriate based on widely-used standards.

Further, a main current is made to flow through the welding point P1 of the laminate W10 in the period t₁, and a large current is made to flow through the welding point P1 of the laminate W10 for a period t₂. The period t₁ is preferably longer than the period t₂ so that burrs are unlikely to be formed.

As shown in FIG. 4, a distance L1 between the welding point P1 and a welded welding point WP1, and a distance L2 between the welding point P1 and a welded welding point WP2 may be determined as appropriate. The distances L1 and L2 are not particularly limited and can be selected from a wide range of values, and may be, for example, 15 mm or 30 mm.

When the main current is made to flow through the welding point P1 of the laminate W10 in step ST1 as shown in FIG. 2, the main current passes through the welding point P1 and flows in a thickness direction (in this example, Z direction) of the laminate W10. The energization path is ensured in such a way that the current passes through the welding point P1 and the laminate W10 from the electrode E1 and flows through the electrode E2. A nugget N1 is formed inside the laminate W10 from the welding point P1 of the laminate W10. Specifically, the nugget N1 is formed in the metal plate W1 and the metal plate W2. The nugget N1 mainly grows in a planar direction (in this example, XY direction) of the laminate W10. In step ST1, in many cases, the nugget N1 grows inside the metal plate W1 and the metal plate W2, but the nugget N1 does not reach inside the metal plate W3.

Next, after step ST1 as well, the welding point P1 of the laminate W10 is continuously energized while it is pressurized, and a large current is made to flow through the welding point P1 of the laminate W10 (step ST2). Specifically, the current is increased from the current value A1 to a current value A2, and the welding point P1 is continuously energized while it is pressurized. As shown in FIGS. 2 and 3, a large current is made to flow through the welding point P1 of the laminate W10 at the current value A2 in the period t₂. Accordingly, the nugget N1 grows so that it reaches inside the metal plate W3. As a result, the nugget N1 grows inside the metal plate W1, the metal plate W2, and the metal plate W3 so that the nugget N1 has a sufficiently large size.

The current curve CA1 shown in FIG. 3 shows changes in the current value according to the manufacturing method. As shown in FIG. 3, the current value A1 of the main current is smaller than the current value A2 of the large current. The current ratio A2/A1 of the current value A2 to the current value A1 may be, for example, 1.4 or larger, and more specifically, 1.4 or larger and 1.7 or smaller. The current value A2 may be, for example, 11 kA or larger, and more specifically, 12 kA or larger. Even when the thickness of the metal plate W3 is small, the welding may be performed with a high welding quality.

Further, the period t₁ is preferably longer than the period t₂ so that burrs are unlikely to be formed. Further, the period t₁ is preferably 1.00 or more times longer than the period t₂, and more preferably, 2.50 or more times longer than the period t₂. Further, the period t₁ is preferably 2.8 or more times longer but not more than 5.0 times longer than the period t₂. Further, the period t₂ is preferably 4 cyc or larger and 7 cyc or smaller. By defining the range of the period t₁ and the range of the period t₂ in this manner, formation of burrs can be further reduced.

From the above description, the nugget N1 is solidified, and the metal plates W1, W2, and W3 of the laminate W10 are welded together. That is, a welded structure in which the metal plates W1, W2, and W3 of the laminate W10 are welded together can be manufactured. In the aforementioned method for manufacturing the welded structure according to the first embodiment, the main current and the large current are unlikely to flow through the welding points WP1 and WP2 in a divided manner from the welding point P1 in the planar direction of the laminate W10, and flows in the thickness direction of the laminate W10 from the welding point P1. It is therefore possible to reduce formation of burrs at the welding point P1.

Further, it is possible that the distances L1 and L2 shown in FIG. 4 may be short. In this case as well, in the aforementioned method for manufacturing the welded structure according to the first embodiment, the main current and the large current are unlikely to flow through the welded welding points WP1 and WP2 in a divided manner from the welding point P1 in the planar direction of the laminate W10, and are likely to flow from the welding point P1 in the thickness direction of the laminate W10. As a result, the nugget N1 grows inside the metal plates W1, W2, and W3, and the metal plates W1, W2, and W3 are welded together with a high welding quality. Therefore, burrs are unlikely to be formed at the welding point P1. That is, in a case where the distances L1 and L2 shown in FIG. 4 are short as well, the aforementioned method for manufacturing the welded structure according to the first embodiment is preferable.

### Second Embodiment

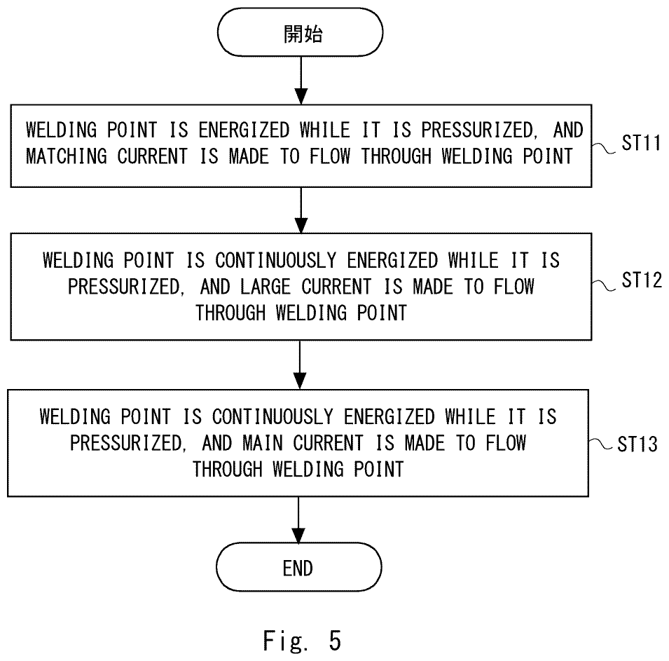

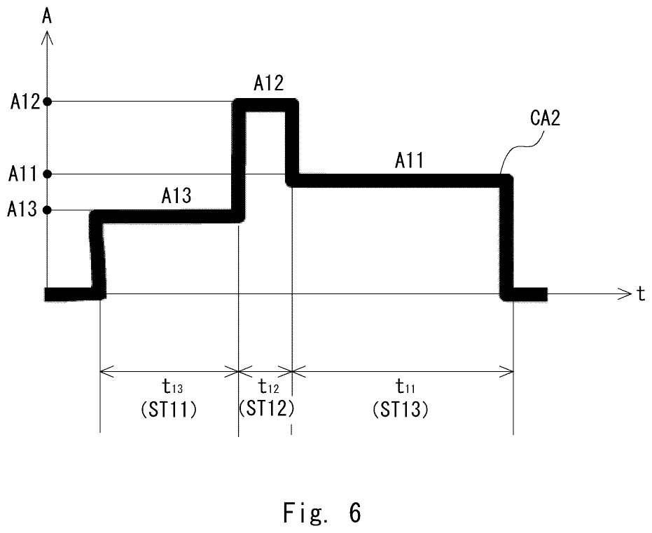

Referring to FIGS. 2, 5, and 6, a second embodiment will be described. FIG. 5 is a flowchart showing a method for manufacturing a welded structure according to the second embodiment. FIG. 6 is a graph showing changes in a current in the method for manufacturing the welded structure shown in FIG. 5.

In the method for manufacturing the welded structure according to the second embodiment, like in the method for manufacturing the welded structure according to the aforementioned first embodiment, the welding apparatus E10 shown in FIG. 2 can be used.

As shown in FIG. 2, the welding point P1 of the laminate W10 is energized while it is pressurized, and a matching current is made to flow through the welding point P1 of the laminate W10 (step ST11). Specifically, the matching current is made to flow while the electrodes E1 and E2 keep pressing the welding point P1. As shown in FIGS. 2 and 6, the matching current is made to flow through the welding point P1 of the laminate W10 at a current value A13 for a period t 13. Further, the diameters of the electrodes E1 and E2 and the welding pressure at which the electrodes E1 and E2 press the welding point P1 may be selected as appropriate based on widely-used standards.

When the matching current is made to flow through the welding point P1 of the laminate W10 in step ST11, the matching current flows in the thickness direction (in this example, Z direction) of the laminate W10 from the welding point P1. Accordingly, the temperature of the laminate W10 increases and the electrical resistivity of the laminate W10 decreases. The energization path is secured so that the current passes through the welding point P1 and the laminate W10 from the electrode E1 and flows through the electrode E2. Note that the nugget N1 is unlikely to be formed in the laminate W10.

Next, the welding point P1 of the laminate W10 is continuously energized while it is pressurized, and a large current is made to flow through the welding point P1 of the laminate W10 (step ST12). Specifically, the current is increased from the current value A13 to the current value A12, and the welding point P1 is continuously energized while it is pressurized. As shown in FIGS. 2 and 6, the large current is made to flow through the welding point P1 of the laminate W10 at the current value A12 in the period t₁₂. Accordingly, the nugget N1 occurs in the laminate W10 and grows in the thickness direction (in this example, Z-axis direction) of the laminate W10. As a result, the nugget N1 grows inside the metal plates W1, W2, and W3.

Lastly, the welding point P1 of the laminate W10 is continuously energized while it is pressurized, and a main current is made to flow through the welding point P1 of the laminate W10 (step ST13). Specifically, the current is decreased from the current value A12 to the current value A11, and the welding point P1 is continuously energized while it is pressurized. As shown in FIGS. 2 and 6, the main current is made to flow through the welding point P1 of the laminate W10 at the current value A11 in the period t₁₁. Accordingly, the nugget N1 grows in the planar direction (in this example, XY direction) of the laminate W10. As a result, the nugget N1 grows inside the metal plates W1, W2, and W3 until the nugget N1 has a sufficiently large size.

A current curve CA2 shown in FIG. 6 shows changes in the current value according to this manufacturing method. As shown in FIG. 6, the current value A13 of the matching current is smaller than the current value A11 of the main current. The current value A11 of the main current is smaller than the current value A12 of the large current. The current ratio A13/A11 of the current value A13 to the current value A11 is preferably, for example, 0.95 or smaller, and specifically, 0.65 or larger and 0.95 or smaller. By defining the range of the current ratio A13/A11 in this manner, it is possible to reduce formation of burrs.

Further, the period t₁₁ may be 2.50 or more times longer than the period t₁₂, and more preferably, 2.86 or more times longer but not more than 5.00 times longer than the period t₁₂. Further, the period t₁₁ may be longer than the period t₁₃ by 3.00 or less times, and more preferably, 2.00 or more times longer but not more than 2.90 times longer than the period t₁₃. By defining the period t₁₁, the period t₁₂, and the period t₁₃ in this manner, it is possible to reduce formation of burrs.

From the above description, the nugget N1 is solidified and the metal plates W1, W2, and W3 of the laminate W10 are welded together. That is, the welded structure in which the metal plates W1, W2, and W3 of the laminate W10 are welded together can be manufactured. In the aforementioned method for manufacturing the welded structure according to the second embodiment, the main current and the large current are unlikely to flow through the welded welding points WP1 and WP2 in a divided manner from the welding point P1 in the planar direction of the laminate W10, and flow from the welding point P1 in the thickness direction of the laminate W10. It is therefore possible to reduce formation of burrs at the welding point P1.

### EXAMPLES

Next, Examples in which the method for manufacturing the welded structure according to each of the aforementioned first and second embodiments is executed will be described.

In Examples 1-5, by using one example of the method for manufacturing the welded structure according to the first embodiment, a laminate was welded together to manufacture a welded structure under the conditions shown in Table 1 below. As a result of a mild steel plate, a steel plate for hot stamping formed of a hot stamping material, and an ultra-high tensile strength steel plate laminated to one another, the laminate is formed. The detailed manufacturing conditions are as follows. That is, the thickness of the mild steel plate was 0.65 mm, the thickness of the steel plate for hot stamping was 1.8 mm, the thickness of the ultra-high tensile strength steel plate was 1.6 mm, the total plate thickness of the laminate was 4.50 mm, the plate thickness ratio of the laminate was 6.23, the diameter of the electrode was 6 mm, the welding pressure at which the electrode presses the laminate was 3820 kN, and the distance between the welding point and the welded welding point was 15 mm. In the comparative example 1, as shown in Table 1, the manufacturing conditions are the same as those in Example 1 except for the period t₂ during which the large current is made to flow.

In Examples 6-12, using one example of the method for manufacturing the welded structure according to the second embodiment, a laminate was welded together to manufacture the welded structure under the conditions shown in Table 2 below. This laminate has a structure the same as those used in Examples 1-5. The detailed manufacturing conditions are the same as those in Examples 1-5. Note that, in the comparative examples 2-5, the manufacturing conditions are the same as those in Examples 6-12 except for the current and the period shown in Table 2. For example, in the comparative example 2, step ST11 is omitted.

The welding qualities of the welded structures according to the examples and the comparative examples were evaluated. Specifically, the welding quality was evaluated as good (OK) when no burrs formed in the welding point of the welded structure in each of the examples and the comparative examples and evaluated as no good (NG) when burrs have been formed. FIG. 10 shows one specific example B1 of burrs. The results of the evaluation are shown in Tables 1 and 2.

TABLE 1

| | Main current | | Large Current | | | | |
|---|---|---|---|---|---|---|---|
| | Current | | Current | | Current | Period | |
| | Value | Period | Value | Period | ratio | ratio | |
| | A1 | t₁ | A2 | t₂ | A2/A1 | t₁/t₂ | Evaluation |
| No. | kA | cyc | kA | cyc | — | — | — |
| Example 1 | 7.7 | 20 | 13 | 4 | 1.69 | 5.00 | OK |
| Comparative | 7.7 | 20 | 13 | 22 | 1.69 | 0.91 | NG |
| example 1 | | | | | | | |
| Example 2 | 7.7 | 20 | 13 | 7 | 1.69 | 2.86 | OK |
| Example 3 | 7.7 | 20 | 13 | 6 | 1.56 | 3.33 | OK |
| Example 4 | 7.7 | 20 | 11 | 6 | 1.43 | 3.33 | OK |
| Example 5 | 7.7 | 20 | 12 | 6 | 1.56 | 3.33 | OK |

In Examples 1-5, the evaluation was OK and no burrs were formed. On the other hand, in the comparative example 1, the evaluation was NG and burrs were formed. One of the reasons for this is that the period ratio t₁/t₂ according to the comparative example 1 was 0.91, which was smaller than those in Examples 1-5.

TABLE 2

| | | | | | | | Current | Period | Current | Period | |
|---|---|---|---|---|---|---|---|---|---|---|---|
| | Matching current | | Large current | | Main current | | ratio | ratio | ratio | ratio | |
| | Current | Period | Current | Period | Current | Period | A12/ | t₁₁/ | A13/ | t₁₁/ | |
| | value A13 | t₁₃ | value A12 | t₁₂ | value A11 | t₁₁ | A11 | t₁₂ | A11 | t₁₃ | Evaluation |
| No. | kA | cyc | kA | cyc | kA | cyc | — | — | — | — | — |
| Example 6 | 5 | 10 | 13 | 4 | 7.7 | 20 | 1.69 | 5.00 | 0.65 | 2.00 | OK |
| Comparative | — | — | 13 | 4 | 7.7 | 20 | 1.69 | 5.00 | — | — | NG |
| example 2 | | | | | | | | | | | |
| Comparative | 5 | 10 | 13 | 10 | 7.7 | 20 | 1.69 | 2.00 | 0.65 | 2.00 | NG |
| example 3 | | | | | | | | | | | |
| Example 7 | 5 | 10 | 12 | 7 | 7.7 | 20 | 1.56 | 2.86 | 0.65 | 2.00 | OK |
| Example 8 | 5 | 10 | 12 | 5 | 7.7 | 20 | 1.56 | 4.00 | 0.65 | 2.00 | OK |
| Example 9 | 5 | 10 | 11 | 7 | 7.7 | 20 | 1.43 | 2.86 | 0.65 | 2.00 | OK |
| Example 10 | 5 | 10 | 12 | 7 | 7.7 | 29 | 1.56 | 4.14 | 0.65 | 2.90 | OK |
| Comparative | 8 | 10 | 13 | 4 | 7.7 | 20 | 1.69 | 5.00 | 1.04 | 2.00 | NG |
| example 4 | | | | | | | | | | | |
| Example 11 | 7.3 | 10 | 13 | 4 | 7.7 | 20 | 1.69 | 5.00 | 0.95 | 2.00 | OK |
| Comparative | 5 | 6 | 13 | 4 | 7.7 | 20 | 1.69 | 5.00 | 0.65 | 3.33 | NG |
| example 5 | | | | | | | | | | | |
| Example 12 | 5 | 8 | 13 | 4 | 7.7 | 20 | 1.69 | 5.00 | 0.65 | 2.50 | OK |

In Example 6, the evaluation was OK and no burrs were formed. On the other hand, in the comparative example 2, the evaluation was NG and burrs were formed. One of the reasons for this is that step ST11 was executed in Example 6, whereas step ST11 is not executed in the comparative example 2.

In Examples 6-10, the evaluation was OK and no burrs were formed. On the other hand, in the comparative example 3, the evaluation was NG and burrs were formed. One of the reasons for this is that the period ratios t₁₁/t₁₂ in Examples 6-10 were 2.86-5.00, which were larger than that in the comparative example 3.

In Example 11, the evaluation was OK and no burrs were formed. On the other hand, in the comparative example 4, the evaluation was NG and burrs were formed. One of the reasons for this is that the current ratio A13/A11 in Example 11 was 0.95, which was smaller than that in the comparative example 4.

In Example 12, the evaluation was OK and no burrs were formed. On the other hand, in the comparative example 5, the evaluation was NG and burrs were formed. One of the reasons for this is that the period ratio t₁₁/t₁₃ in Example 12 was 2.50, which was smaller than that in the comparative example 5.

Note that the present disclosure is not limited to the aforementioned embodiments and may be changed as appropriate without departing from the spirit of the present disclosure. Further, the present disclosure may be executed by combining the aforementioned embodiments and one example thereof as appropriate.

For example, the method for manufacturing the welded structure according to each of the aforementioned first and second embodiments may further include a step of determining a method for welding the welding point P1 to be welded based on the position of the welding point P1 to be welded.

In the step of determining the welding method, when the distances L1 and L2 between the welding point P1 to be welded and the welded welding points WP1 and WP2 exceed a predetermined value, the welding point P1 of the laminate W10 is energized while it is pressurized, and a large current is made to flow through the welding point P1 of the laminate W10. The welding point P1 of the laminate W10 is continuously energized while it is pressurized, and a main current that is smaller than the large current is made to flow through the welding point P1 of the laminate W10.

On the other hand, when the distances L1 and L2 are equal to or smaller than a predetermined value, steps ST1 and ST2 of the method for manufacturing the welded structure according to the first embodiment may be executed and the welding point P1 to be welded may be welded.

Further, when the distances L1 and L2 are equal to or smaller than the predetermined value, steps ST11, ST12, and ST13 in the method for manufacturing the welded structure according to the second embodiment may be executed and the welding point P1 to be welded may be welded.

Further, the control unit E4 of the welding apparatus E10 may include a recording unit and a welding method determination unit. This recording unit records the distances L1 and L2 in advance. The welding method determination unit determines a method for welding the welding point P1 to be welded based on the distances L1 and L2.

From the above description, the method for manufacturing the welded structure according to each of the aforementioned first and second embodiments may further include a step of determining a method for welding the welding point P1 to be welded based on the position of the welding point P1 to be welded. In this case, it is possible to weld the welding point P1 to be welded using the welding method in accordance with the distances L1 and L2. Specifically, a welding point where burrs are not likely to be formed is welded using the method for manufacturing the welded structure according to the art related to the present disclosure. On the other hand, a welding point where burrs will likely to be formed may be welded using the method for manufacturing the welded structure according to the first and second embodiments.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A method for manufacturing a welded structure formed by spot-welding a laminate formed of three or more metal plates laminated to one another, at least one of the three or more metal plates being thinner than the other metal plates, the method comprising:
energizing a welding point of the laminate while pressurizing it and causing a main current to flow through the welding point of the laminate; and
continuously energizing the welding point of the laminate while pressurizing it and causing a large current that is larger than the main current to flow through the welding point of the laminate,
wherein a period t₁ during which the main current is made to flow through the welding point of the laminate is longer than a period t₂ during which the large current is made to flow through the welding point of the laminate.

2. The method for manufacturing the welded structure according to claim 1, wherein the period t₁ during which the main current is made to flow through the welding point of the laminate is 2.50 or more times longer than the period t₂ during which the large current is made to flow through the welding point of the laminate.

3. The method for manufacturing the welded structure according to claim 1, wherein a current value A2 of the large current is 12 kA or larger.

4. A method for manufacturing a welded structure formed by spot-welding a laminate formed of three or more metal plates laminated to one another, at least one of the three or more metal plates being thinner than the other metal plates, the method comprising:
energizing a welding point of the laminate while pressurizing it and causing a matching current to flow through the welding point of the laminate;
continuously energizing the welding point of the laminate while pressurizing it and causing a large current to flow through the welding point of the laminate; and
continuously energizing the welding point of the laminate while pressurizing it and causing a main current that is smaller than the large current to flow through the welding point of the laminate,
wherein a current value A13 of the matching current is smaller than a current value A11 of the main current.

5. The method for manufacturing the welded structure according to claim 4, wherein a period t₁₁ during which the main current is made to flow through the welding point of the laminate is 2.50 or more times longer than a period t₁₂ during which the large current is made to flow through the welding point of the laminate.

6. The method for manufacturing the welded structure according to claim 4, wherein a period t₁₁ during which the main current is made to flow through the welding point of the laminate is longer than a period t₁₃ during which the matching current is made to flow through the welding point of the laminate by 3.00 or less times.

7. The method for manufacturing the welded structure according to claim 4, wherein the current value A13 of the matching current is 0.95 or less times as large as the current value A11 of the main current.

8. The method for manufacturing the welded structure according to claim 1, wherein
the laminate includes a welded welding point that has already been welded, and
the welding point of the laminate is within 15 mm from the welded welding point.

9. A method for manufacturing a welded structure formed by spot-welding a laminate formed of three or more metal plates laminated to one another, at least one of the three or more metal plates being thinner than the other metal plates, the method comprising:
determining, based on a position of a welding point to be welded, a method for welding the welding point to be welded, wherein
in the determination of the welding method,
when a distance between the welding point to be welded and a welded welding point exceeds a predetermined value, the welding point of the laminate is energized while it is pressurized and a large current is made to flow through the welding point of the laminate, and then the welding point of the laminate is continuously energized while it is pressurized and a main current that is smaller than the large current is made to flow through the welding point of the laminate, and
when the distance between the welding point to be welded and the welded welding point is a predetermined value or smaller, the welding point to be welded is welded using a welding method in which the welding point of the laminate is energized while it is pressurized and a main current is made to flow through the welding point of the laminate, and then the welding point of the laminate is continuously energized while it is pressurized and a large current that is larger than the main current is made to flow through the welding point of the laminate, and a period t₁ during which the main current is made to flow through the welding point of the laminate is longer than a period t₂ during which the large current is made to flow through the welding point of the laminate.
